(19) United States
(12) Patent Application Publication
(10) Pub. No.: US 2006/0072464 A1
(43) Pub. Date: Apr. 6, 2006

(54) Detection of encrypted packet streams

(76) Inventors: Jeffrey A. Aaron, Atlanta, GA (US); Edgar Vaughan Shrum JR., Smyrna, GA (US)

Correspondence Address: SCOTT P. ZIMMERMAN, PLLC, PO BOX 3822, CARY, NC, 27519, US

(21) Appl. No.: 10/944,294

(22) Filed: Sep. 17, 2004

(51) Int. Cl. H04L 12/26

(52) U.S. Cl. 370/241; 380/255

(57) ABSTRACT

Methods, systems, and products are disclosed for detecting encrypted Internet Protocol packet streams. One method selects a subset of observable parameters from a set of observable parameters. The existence of at least one of the observable parameters within the subset is noted within an encrypted stream of packets. The at least one of the observable parameters is observable despite encryption obscuring the contents of the encrypted stream of packets. The type of data within the encrypted stream of packets is inferred using the at least one of the observable parameters.

### CROSS-REFERENCE TO RELATED APPLICATIONS

This application relates to the commonly assigned and concurrently filed U.S. application Ser. No. XX/XXX,XXX, entitled “Detection of Encrypted Packet Streams” (Attorney Docket BS040215); Ser. No. XX/XXX,XXX, entitled “Signature Specification for Encrypted Packet Streams” (Attorney Docket BS040216); Ser. No. XX/XXX,XXX, entitled “Detection of Encrypted Packet Streams Using a Timer” (Attorney Docket BS040279); Ser. No. XX/XXX,XXX, entitled “Detection of Encrypted Packet Streams Using Process Variation and/or Multiple Processes” (Attorney Docket BS040280) ; and Ser. No. XX/XXX,XXX, entitled “Detection of Encrypted Packet Streams Using Feedback Probing” (Attorney Docket BS040281). These commonly-assigned applications are all incorporated by reference.

### NOTICE OF COPYRIGHT PROTECTION

A portion of the disclosure of this patent document and its figures contain material subject to copyright protection. The copyright owner has no objection to the facsimile reproduction by anyone of the patent document or the patent disclosure, but otherwise reserves all copyrights whatsoever.

### BACKGROUND

The exemplary embodiments generally relate to multiplexed communications and, more particularly, to path finding or routing a message with an address header.

Encryption of communications is increasing. More and more people, businesses, and governments are encrypting their electronic communications. This encryption provides enhanced security and privacy for these electronic communications.

Encryption, however, is a problem for communications service providers. Communications service providers need to know the type of data contained within an electronic communication. Some data types receive priority processing, while other data types are queued for later processing. Encryption, however, hides the contents of the communication and often prevents a communications service provider from determining the level of required processing. Because the communications service provider cannot determine the level of required processing, the encrypted communication defaults to lesser priority and/or processing.

Internet telephony provides an example. Internet telephone calls should be processed to result in a real time, or nearly real time, conversation. If packets are lost, or if packets experience congestion, the quality of the call suffers. Internet telephone calls, then, should receive priority processing. When a communications service provider detects data representing an Internet telephone call, the service provider gives that data priority/special processing to reduce packet loss and to reduce latency effects. Encryption, however, hides the contents of the communication. Encryption prevents the communications service provider from determining whether priority and/or special processing is required. So, even though the communication is an Internet telephone call, encryption causes the communication to default to lesser priority and/or processing. The quality of the call may then suffer from packet loss and congestion.

There is, accordingly, a need in the art for improved determination of data types. When parties encrypt their communications, there is a need for determining the type of data contained inside the encrypted communication. There is also a need for identifying a particular kind of encrypted traffic in order to provide prioritized/specialized processing.

### SUMMARY

The aforementioned problems, and other problems, are reduced by methods, computer systems, computer programs, and computer program products that detect the type of data contained within an encrypted stream of packets. The exemplary embodiments utilize a set of observable parameters to infer the type of data contained within the encrypted stream of packets. A subset of the observable parameters, from within the set of observable parameters, is then selected. The subset may include one, some, all, or any combination of the parameters within the set of observable parameters. Once the subset is chosen, the exemplary embodiments then use one or more parameters from the subset to infer what type of data is contained within the encrypted stream of packets.

The exemplary embodiments may utilize various techniques to infer what type of data is contained within the encrypted stream of packets. A weighted combination, for example, of the observable parameters within the subset may be used. The exemplary embodiments may additionally or alternatively use any mathematical expression involving some combination of the observable parameters within the subset. The exemplary embodiments may also require that one or more than one of the observable parameters within the subset agree to the type of data within the encrypted stream of packets. The exemplary embodiments may require that a majority of the observable parameters agree, and/or all of the observable parameters within the subset agree, to the type of data within the encrypted stream of packets. The exemplary embodiments may even vary the selection of the subset of observable parameters, and/or periodically change the selected subset of observable parameters, to thwart hackers and/or to improve detection of the type of data.

One method selects a subset of observable parameters from a set of observable parameters. The existence of at least one of the observable parameters within the subset is noted within an encrypted stream of packets. The at least one of the observable parameters is observable despite encryption obscuring the contents of the encrypted stream of packets. The type of data within the encrypted stream of packets is inferred using the at least one of the observable parameters.

Another of the embodiments describes a method of inferring Voice Over Internet Protocol data. Here a subset of observable parameters, from a set of observable parameters, is selected. The existence of at least one of the observable parameters within the subset is noted in an encrypted stream of packets. The at least one of the observable parameters is observable despite encryption obscuring the contents of the encrypted stream of packets. Voice Over Internet Protocol data within the encrypted stream of packets is inferred using the at least one of the observable parameters.

Yet another of the embodiments describes a system for inferring Voice Over Internet Protocol data. A memory device stores a communications module, and a processor communicates with the memory device. The communications module selects a subset of observable parameters from a set of observable parameters, the communications module notes at least one of the observable parameters within the subset in an encrypted stream of packets, the at least one of the observable parameters being observable despite encryption obscuring the contents of the encrypted stream of packets, and the communications module infers Voice Over Internet Protocol data within the encrypted stream of packets using the at least one of the observable parameters.

Still another of the embodiments describes a computer program product for inferring Voice Over Internet Protocol data. This computer program product includes a communications module stored on a computer-readable medium. The communications module selects a subset of observable parameters from a set of observable parameters, the communications module notes at least one of the observable parameters within the subset in an encrypted stream of packets, the at least one of the observable parameters being observable despite encryption obscuring the contents of the encrypted stream of packets, and the communications module infers Voice Over Internet Protocol data within the encrypted stream of packets using the at least one of the observable parameters.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE SEVERAL VIEWS OF THE DRAWINGS

These and other features, aspects, and advantages of the embodiments of the present invention are better understood when the following Detailed Description is read with reference to the accompanying drawings, wherein:

FIG. 1 is a schematic illustrating the exemplary embodiments;

FIG. 2 is a schematic illustrating a technique for inferring the type of data contained within an encrypted stream of packets, according to the exemplary embodiments;

FIGS. 3-5 are schematics illustrating various strategies for inferring the type of data within an encrypted stream of packets;

FIG. 6 is a schematic applying the teachings of this invention to infer Voice Over Internet Protocol data, according to more exemplary embodiments; and

FIG. 7 is a flowchart illustrating a method of detecting encrypted packet streams, according to still more exemplary embodiments.

### DETAILED DESCRIPTION

This exemplary embodiments now will be described more fully hereinafter with reference to the accompanying drawings. The exemplary embodiments may, however, be embodied in many different forms and should not be construed as limited to the embodiments set forth herein. These embodiments are provided so that this disclosure will be thorough and complete and will fully convey the scope of the exemplary embodiments to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating systems and methods embodying the exemplary embodiments. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named manufacturer.

The exemplary embodiments detect the type of data contained within an encrypted stream of packets. The exemplary embodiments utilize a set of observable parameters to infer the type of data contained within the encrypted stream of packets. A subset of the observable parameters from within the set of observable parameters is selected. The subset may include one, some, all, or any combination of the parameters within the set of observable parameters. Once the subset is chosen, the exemplary embodiments then use one or more parameters from the subset to infer what type of data is contained within the encrypted stream of packets.

The exemplary embodiments may utilize various techniques to infer what type of data is contained within the encrypted stream of packets. The exemplary embodiments, for example, may use a weighted combination of the observable parameters within the subset. The exemplary embodiments may additionally or alternatively use any mathematical expression involving some combination of the observable parameters within the subset. The exemplary embodiments may also require that one or more than one of the observable parameters within the subset agree to the type of data within the encrypted stream of packets. The exemplary embodiments may require that a majority of the observable parameters agree, and/or all of the observable parameters within the subset agree, to the type of data within the encrypted stream of packets. The exemplary embodiments may even vary the selection of the subset of observable parameters, and/or periodically change the selected subset of observable parameters, to thwart hackers and/or to improve detection of the type of data.

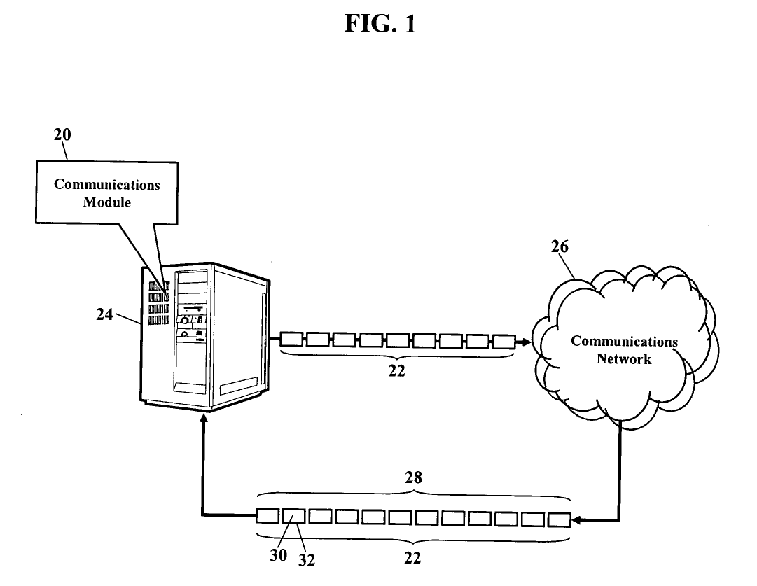

FIG. 1 is a schematic illustrating the exemplary embodiments. The include a communications module 20. The communications module 20 comprises methods, systems, computer programs, and/or computer program products that help provide communications services. The communications module 20, in particular, detects an encrypted stream 22 of Internet Protocol packets. The communications module 20 operates within any computer system, such as a communications server 24. The communications module 20 receives the encrypted stream 22 of packets via a communications network 26. Because the stream 22 of packets is encrypted, the encryption obscures the contents of the stream 22 packets. The communications module 20, however, is able to discern one or more observable parameters 28 within the encrypted stream 22 of packets. The communications module 20 is able to observe the parameters 28, despite encryption obscuring the contents 30 of each packet 32 within the stream 22 of packets. As the following paragraphs explain, the communications module 20 uses various techniques involving one or more of the observable parameters 28 to infer the type of data contained within the contents 30 of each packet 32 within the stream 22 of packets.

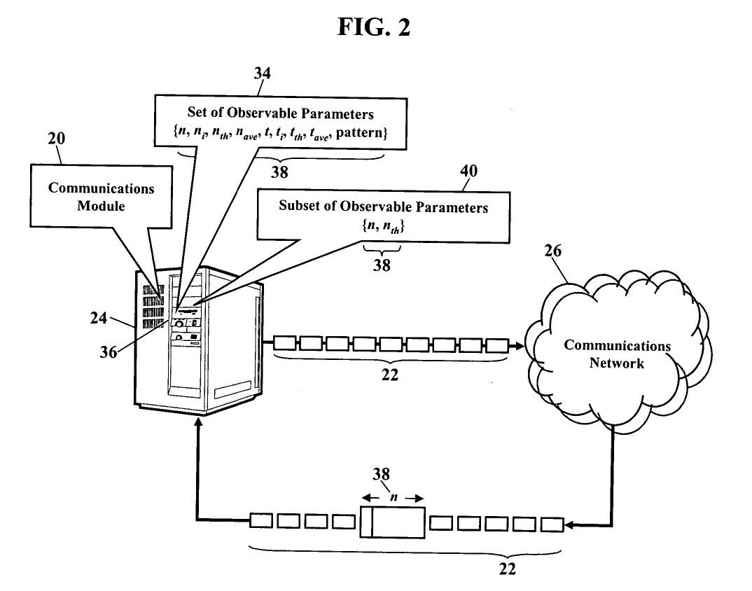

FIG. 2 is a schematic illustrating a technique the communications module 20 uses to infer the type of data contained within the contents 30 of each packet 32, according to the exemplary embodiments. The communications module 20 consults a set 34 of observable parameters stored in memory 36 of the communications server 24. Each parameter 38 within the set 34 of observable parameters describes some characteristic that might be observed within the stream 22 of packets, despite the encryption. Some of the observable characteristics may include, for example, the size n of each encrypted packet and/or the average packet size nₐᵥₑ. Some other observable characteristics may include the timing interval t and/or the average timing interval tₐᵥₑ. Still other observable characteristics may include observable patterns involving a constant or nearly constant packet size nᵢ, a constant or nearly constant timing interval ti between adjacent packets, and/or a constant or nearly constant presence of transmitted packets from an originating communications device and/or address. The observable patterns may additionally or alternatively involve a constant or nearly constant presence of packets destined to a terminating communications device and/or address. The observable patterns may additionally or alternatively involve recognizable/repeating periods of packets interspersed with recognizable/repeating periods of no packets. Whatever each parameter 38 may specify, each parameter 38 describes some characteristic that might be observed within the stream 22 of packets, despite the encryption. This patent, however, will not describe in detail the observable parameters 28. If the reader desires to learn more about the observable parameters 28, the reader is invited to consult the commonly assigned and concurrently filed U.S. application Ser. No. XX/XXX,XXX, entitled “Detection of Encrypted ” (Attorney Docket BS040215), of which the “Brief Summary of the Invention” section and the “Detailed Description of the Invention” section are incorporated by reference.

As FIG. 2 illustrates, the communications module 20 forms a subset 40 of observable parameters. The communications module 20 consults the set 34 of observable parameters and selects a subset 40 of observable parameters. That is, the communications module 20 selects one, some, or all of the parameters 38 within the set 34 of observable parameters to create the subset 40. The communications module 20 preferably autonomously and randomly selects the subset 40 such that the subset 40 randomly changes composition. Because the communications module 20 selects the subset 40, the selected parameters randomly change, thus helping thwart hackers. The communications module 20, of course, could deterministically select the subset 40 according to some sequence, formula, and/or schedule. The communications module 20 could also be instructed by an administrator/user when to select the subset 40, and/or what parameters to select, when forming the subset 40.

Once the subset 40 is selected, the communications module 20 then observes the stream 22 of packets. The communications module 20 notes whether at least one of the observable parameters 38, specified by the subset 40, occurs and/or exists within encrypted stream 22 of packets. As this patent above explained, one or more of the observable parameters 38 may be observable despite encryption obscuring the contents of the encrypted stream 22 of packets. The communications module 20 then infers the type of data within the encrypted stream 22 of packets using any combination of the observable parameters 38 within the subset 40. The communications module 20, for example, may compare the bitsize n of an encrypted packet to a threshold packet size nₜₕ. The threshold packet size nₜₕ describes a known packet size of a known type of data. The threshold packet size nₜₕ, for example, might be a known value for packets containing video data, text file data, picture data, and/or any other known type of data. If the packet size n satisfies the threshold packet size nₜₕ, then the communications module 20 can infer the type of data contained within the encrypted packet matches the known type of data corresponding to the threshold packet size nₜₕ. When the subset 40 contains other parameters that might be observed within encrypted stream 22 of packets, the communications module 20 might also compare each observable parameter to a corresponding threshold value. The communications module 20 then gathers the results of each threshold comparison and infers the type of data within the encrypted stream 22 of packets using any combination of the observable parameters 38 within the subset 40.

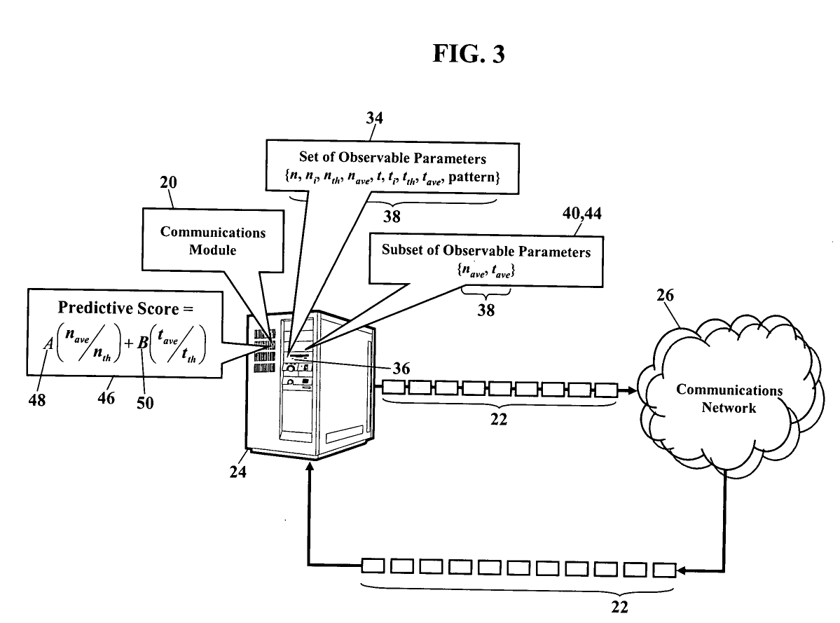

FIGS. 3-5 are schematics illustrating various strategies for inferring the type of data within the encrypted stream 22 of packets. Because the subset 40 may contain several parameters that might be observed within encrypted stream 22 of packets, the communications module 20 can variously combine the observed characteristics to improve the prediction of data types. Some parameters, for example, might more reliably predict data types than other parameters. Some parameters, likewise, might be poor predictors under certain conditions, so the communications module 20 might discount, or even disregard, those comparative results. The communications module 20, then, can use various strategies when combining the observed characteristics to improve the prediction of data types.

FIG. 3, for example, illustrates a weighted combination of the observable parameters for inferring the type of data contained within the encrypted stream 22 of packets, according to the exemplary embodiments. The communications module 20, as before, selects the subset 40 and observes the encrypted stream 22 of packets. The communications module 20 then notes whether any of the observable parameters 38, specified by the subset 40, occur and/or exist within encrypted stream 22 of packets. The communications module 20 may then compare each observed parameter to a corresponding threshold value and calculate a weighted sum, or score, for the observable parameters 38. As FIG. 3 illustrates, a weighting factor 42 may assigned to each parameter 38 within the subset 40. Some parameters might be more reliable for predicting data types, so the more reliable parameters might have greater weights. The parameters with greater weights would have more impact on the final result. Some parameters might only be slightly accurate when predicting data types, so the lesser-accurate parameters might have smaller weighting factors. Any parameter with a comparatively smaller weighting factor will have less impact on the final result.

FIG. 3 illustrates one example of a weighted combination. Suppose the communications module 20 has randomly selected the subset 40 as
[nₐᵥₑ, tₐᵥₑ]
(shown as reference numeral 44). That is, the communications module 20 has randomly selected the subset 40 to include the average packet size nₐᵥₑ and the average timing interval tₐᵥₑ within the encrypted stream 22 of packets. Suppose also that communications module 20 is programmed to calculate a predictive “score” using the weighted sum

$$\text{Predictive Score} = A ( {n}_{ave} / {n}_{th} ) + B ( {t}_{ave} / {t}_{th} )$$

(shown as reference numeral 46). This formulaic predictive score compares 1) the average packet size nₐᵥₑ to the threshold packet size nₜₕ and 2) the average timing interval tₐᵥₑ to the threshold timing interval tₜₕ. This formulaic predictive score also weights each factor using the respective weighting factors “A” and “B” (shown, respectively, as reference numerals 48 and 50). If the weighting factors have the values
A=5, B =1,
then the packet size comparison (nₐᵥₑ/nₜₕ) will have five times the affect on the predictive score. The selected subset 40, of course, may contain more parameters, and thus have more weighting factors. The predictive score formula 46 may, of course, have any terms, factors, and operands that suit the application and/or data. However the subset 40 is selected, and however the formulaic weighted combination is determined, the use of the weighting factors 48, 50 allows some observed parameters to have more impact on the final determination.

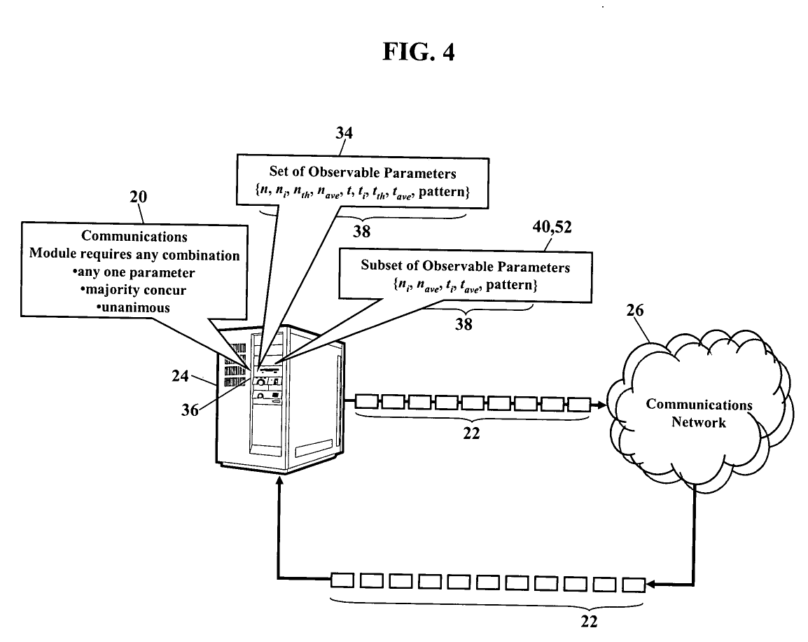

FIG. 4 is another schematic illustrating other strategies for inferring the type of data within the encrypted stream 22 of packets. FIG. 4 illustrates that some combination of the observable parameters within the subset 40 must agree to the type of data within the encrypted stream 22 of packets, according to the exemplary embodiments. The communications module 20, earlier explained, consults the set 34 of observable parameters and selects the subset 40 of observable parameters. Once the subset 40 is selected, the communications module 20 then observes the stream 22 of packets and notes whether any of the observable parameters 38, specified by the subset 40, occurs and/or exists within encrypted stream 22 of packets. When the communications module 20 infers the type of data within the encrypted stream 22 of packets, the communications module 20 may require that one, some, or even all of the observed parameters within the subset 40 commonly agree to the data type.

FIG. 4 illustrates that some combination of the observable parameters within the subset 40 must agree to the type of data within the encrypted stream 22 of packets. Suppose the communications module 20 has randomly selected the subset 40 as
Selected Subset [nᵢ, nₐᵥₑ) tᵢ, tₐᵥₑ, patterns]
(shown as reference numeral 52). That is, the communications module 20 has randomly selected the subset 40 to include an individual packet size nᵢ, the average packet size nₐᵥₑ, an intra-packet timing interval tᵢ, an average timing interval tₐᵥₑ, and any observable packet patterns within the encrypted stream 22 of packets. The communications module 20 may be programmed to require that only one of the parameters 38, specified in the subset 40, predict the type of data within the encrypted stream 22 of packets. The communications module 20, however, will more likely require that more than one of the observable parameters 38 within the subset 40 agree to the type of data. The communications module 20, for example, may require that a majority of the observable parameters 38 within the subset 40 agree to the type of data within the encrypted stream 22 of packets. The communications module 20 may alternatively require that all of the observable parameters 38 within the subset 40 agree to the type of data. If one or more parameters 38 more reliably predict data types, the communications module 20 may even discard the results of the lesser-predictive parameters.

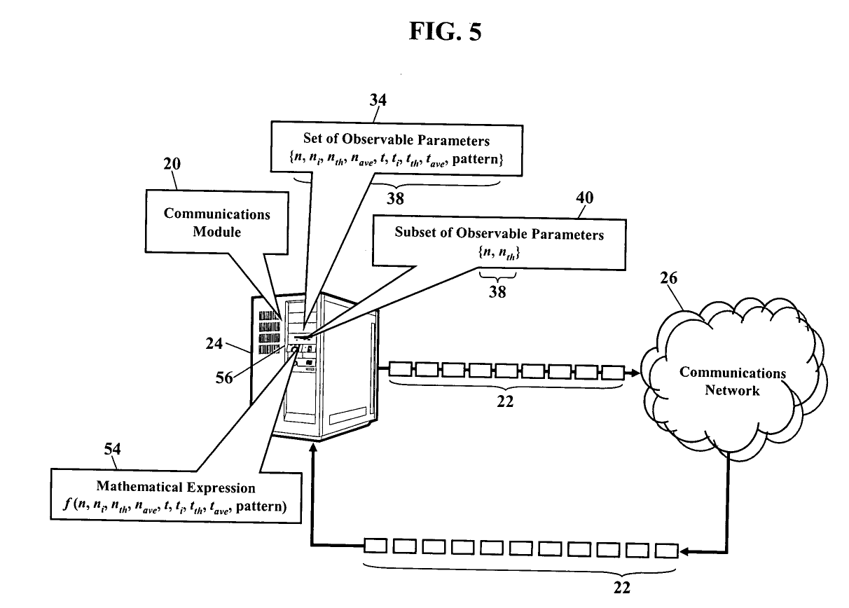

FIG. 5 is another schematic illustrating another strategy for inferring the type of data within the encrypted stream 22 of packets. FIG. 5 illustrates that any mathematical expression, involving some combination of the observable parameters 38 within the subset 40, may be used to predict the type of data within the encrypted stream 22 of packets. The communications module 20 may consult one or more mathematical expressions 54 stored in a memory 56 of the communications server 24. The one or more mathematical expressions 54 may be any function, expression, and/or algorithm involving any one or more of the observable parameters 38 within the subset 40. The result of this mathematical expression may help the communications module 20 infer the type of data contained within the encrypted stream 22 of packets. If the communications module 20 is satisfied with the result of this mathematical expression, then the communications module 20 may infer what type of data is contained within the encrypted stream 22 of packets. If, however, the communications module 20 is not satisfied with the result, then the communications module 20 may decline to infer the type of data contained within the encrypted stream 22 of packets. The one or more mathematical expressions 54 could contain any mathematical expression/algorithm that may help the communications module 20 infer the type of data contained within the encrypted stream 22 of packets.

The subset 40 of observable parameters can help thwart malicious behavior. The communications module 20, as earlier explained, consults the set 34 of observable parameters and selects the subset 40 of observable parameters. The communications module 20 randomly or deterministically selects the subset 40 to vary its composition. The inventors foresee that someone may attempt to conceal the true type of data contained within the stream. Some person may try to manipulate the encrypted stream 24 of data to have characteristics that disguise the true data type. Someone, for example, might want to disguise an encrypted video data stream (such as one containing objectionable, lewd, or even pornographic material) as Voice Over Internet Protocol telephony data. If the person knows that the communications module 20 measures individual packet sizes nᵢ when inferring data types, this person might format the encrypted video data stream to have packet sizes mimicking Voice Over Internet Protocol telephony data. Because the encrypted video data stream is disguised as Voice Over Internet Protocol telephony data, the video stream might successfully route through firewalls and other security measures. The communications module 20, therefore, selects the subset 40 such that the parameters vary. Different subsets may be periodically chosen, depending upon the time of day, the day of the week, or some other schedule. The communications module 20 may randomly choose when to change the composition of the subset 40, and the communications module 20 may randomly select the parameters within each subset. The communications module 20 may even choose to randomly select the subset 40 with each encrypted stream that is received by the communications server 24. All these techniques may be used to thwart malicious behavior by third parties.

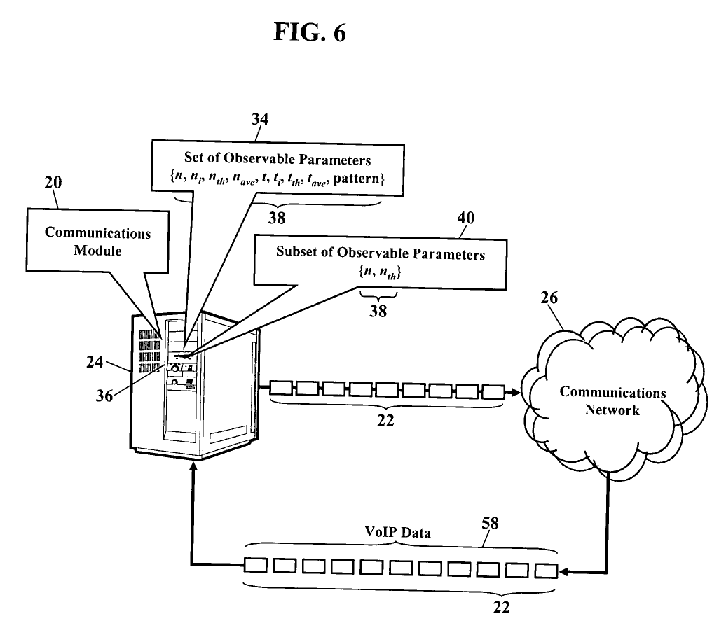

FIG. 6 is a schematic applying the teachings of this invention to the Voice Over Internet Protocol environment. The communications module 20, as before, selects the subset 40 of observable parameters from the set 34 of observable parameters. The communications module 20 then observes the encrypted stream 22 of packets and notes the occurrence or existence, if any, of the observable parameters 28 within the encrypted stream 22 of packets. The communications module 20 compares the one or more observable parameters 28 to one or more threshold values that are characteristic of Voice Over Internet Protocol data. The communications module 20 may use any formulaic weightings, algorithms, and/or comparisons, as earlier described, that involve any combination of the observable parameters 38. The communications module 20 then uses the result to infer the encrypted stream 22 of packets contains Voice Over Internet Protocol (VoIP) data 58.

Because the communications module 20 can infer the existence of the Voice Over Internet Protocol data 58, special processing may be applied. Once the Voice Over Internet Protocol data 58 is inferred, the encrypted stream 22 of packets might receive priority treatment to ensure the quality of the Internet Protocol telephone call. Priority processing helps avoid excess latency that degrades the quality of the telephone call. Even though the communications module 20 cannot read the contents of the encrypted stream 22, the communications module 20 can still exploit the characteristics of the connection to ensure quality of service. Once the communications module 20 infers that the Voice Over Internet Protocol data 58 is present, the communications module 20 can prioritize the encrypted stream 22 for any processing steps that help ensure the encrypted stream 22 is acceptable for voice quality.

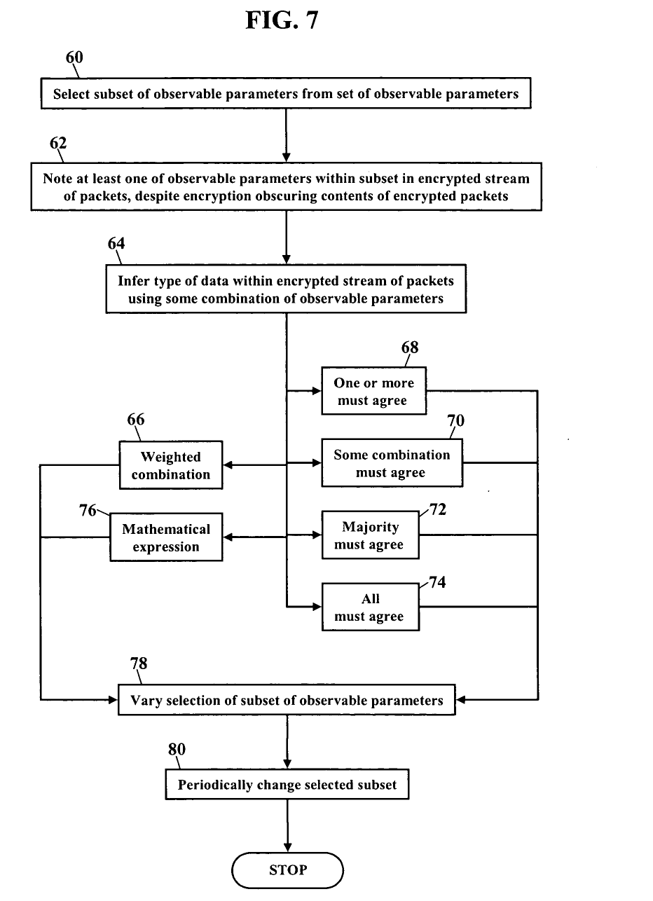

FIG. 7 is a flowchart illustrating a method of detecting encrypted packet streams. A subset of observable parameters is selected from a set of observable parameters (Block 60). The existence or occurrence of at least one of the observable parameters is noted within the subset in an encrypted stream of packets (Block 62). The at least one of the observable parameters is observable despite encryption obscuring the contents of the encrypted stream of packets. The type of data within the encrypted stream of packets is inferred using some combination of the observable parameters (Block 64). A weighted combination of the observable parameters within the subset may be used to infer the type of data (Block 66). One or more of the observable parameters within the subset may be required to agree to the type of data within the encrypted stream of packets (Block 68). Some combination (Block 70), a majority (Block 72), or even all (Block 74) of the observable parameters within the subset may be required to agree to the type of data within the encrypted stream of packets. A mathematical expression involving some combination of the observable parameters within the subset may also be used to infer the type of data within the encrypted stream of packets (Block 76). The selection of the subset of observable parameters may be varied (Block 78), and the selected subset may be periodically changed (Block 80).

The communications module may be physically embodied on or in a computer-readable medium. This computer-readable medium may include CD-ROM, DVD, tape, cassette, floppy disk, memory card, and large-capacity disk (such as IOMEGA®, ZIP®, JAZZ®, and other large-capacity memory products (IOMEGA®, ZIP®, and JAZZ® are registered trademarks of Iomega Corporation, 1821 W. Iomega Way, Roy, Utah 84067, 801.332.1000, www.iomega.com). This computer-readable medium, or media, could be distributed to end-users, licensees, and assignees. These types of computer-readable media, and other types not mention here but considered within the scope of the present invention, allow the communications module to be easily disseminated. A computer program product for detecting the type of data contained within an encrypted stream of packets includes the communications module stored on the computer-readable medium. The communications module includes computer-readable instructions for selecting a subset of observable parameters from a set of observable parameters. The communications module notes at least one of the observable parameters within the subset in an encrypted stream of packets, with the at least one of the observable parameters being observable despite encryption obscuring the contents of the encrypted stream of packets. The communications module infers Voice Over Internet Protocol data within the encrypted stream of packets using the at least one of the observable parameters.

The communications module may also be physically embodied on or in any addressable (e.g., HTTP, I.E.E.E. 802.11, Wireless Application Protocol (WAP)) wire line or wireless device capable of presenting an IP address. Examples could include a computer, a wireless personal digital assistant (PDA), an Internet Protocol mobile phone, or a wireless pager.

While the exemplary embodiments have been described with respect to various features, aspects, and embodiments, those skilled and unskilled in the art will recognize the exemplary embodiments are not so limited. Other variations, modifications, and alternative embodiments may be made without departing from the spirit and scope of the exemplary embodiments.

What is claimed is:

1. A method, comprising the steps of:
selecting a subset of observable parameters from a set of observable parameters;
noting at least one of the observable parameters within the subset in an encrypted stream of packets, the at least one of the observable parameters being observable despite encryption obscuring the contents of the encrypted stream of packets; and
inferring the type of data within the encrypted stream of packets using the at least one of the observable parameters.

2. A method according to claim 1, further comprising at least one of the steps of i) varying the selection of the subset of observable parameters and ii) periodically changing the selected subset of observable parameters.

3. A method according to claim 1, wherein the step of inferring the type of data comprises inferring the type of data within the encrypted stream of packets using a combination of the observable parameters within the subset.

4. A method according to claim 1, wherein the step of inferring the type of data comprises using a weighted combination of the observable parameters within the subset.

5. A method according to claim 1, wherein the step of inferring the type of data comprises requiring that more than one of the observable parameters within the subset agree to the type of data within the encrypted stream of packets.

6. A method according to claim 1, wherein the step of inferring the type of data comprises at least one of i) requiring that a majority of the observable parameters within the subset agree to the type of data within the encrypted stream of packets and ii) requiring that all of the observable parameters within the subset agree to the type of data within the encrypted stream of packets.

7. A method according to claim 1, wherein the step of inferring the type of data comprises requiring that some combination of the observable parameters within the subset agree to the type of data within the encrypted stream of packets.

8. A method according to claim 1, wherein the step of inferring the type of data comprises using a mathematical expression, the mathematical expression involving some combination of the observable parameters within the subset.

9. A method according to claim 1, further comprising the step of comparing to a threshold value.

10. A method according to claim 1, wherein the step of inferring the type of data comprises inferring Voice Over Internet Protocol data within the encrypted stream of packets using the at least one of the observable parameters.

11. A system, comprising:
a communications module stored in a memory device, and a processor communicating with the memory device;
the communications module selecting a subset of observable parameters from a set of observable parameters, the communications module noting at least one of the observable parameters within the subset in an encrypted stream of packets, the at least one of the observable parameters being observable despite encryption obscuring the contents of the encrypted stream of packets, and the communications module inferring the type of data within the encrypted stream of packets using the at least one of the observable parameters.

12. A system according to claim 11, wherein the communications module performs at least one of the steps of i) varying the selection of the subset of observable parameters and ii) periodically changing the selected subset of observable parameters.

13. A system according to claim 11, wherein the communications module infers the type of data within the encrypted stream of packets using a combination of the observable parameters within the subset.

14. A system according to claim 11, wherein the communications module infers the type of data comprises using a weighted combination of the observable parameters within the subset.

15. A system according to claim 11, wherein the communications module performs at least one of the steps of i) requiring that more than one of the observable parameters within the subset agree to the type of data within the encrypted stream of packets, ii) requiring that a majority of the observable parameters within the subset agree to the type of data within the encrypted stream of packets and iii) requiring that all of the observable parameters within the subset agree to the type of data within the encrypted stream of packets.

16. A system according to claim 11, wherein the communications module requires that some combination of the observable parameters within the subset agree to the type of data within the encrypted stream of packets.

17. A system according to claim 11, wherein the communications module infers the type of data comprises using a mathematical expression, the mathematical expression involving some combination of the observable parameters within the subset.

18. A system according to claim 11, wherein the communications module compares to a threshold value.

19. A system according to claim 11, wherein the communications module infers Voice Over Internet Protocol data within the encrypted stream of packets using the at least one of the observable parameters.

20. A computer program product comprising a computer readable medium including instructions for performing the steps:
a computer-readable medium; and
a communications module stored on the computer-readable medium, the communications module selecting a subset of observable parameters from a set of observable parameters, the communications module noting at least one of the observable parameters within the subset in an encrypted stream of packets, the at least one of the observable parameters being observable despite encryption obscuring the contents of the encrypted stream of packets, and the communications module inferring the type of data within the encrypted stream of packets using the at least one of the observable parameters.
